(19) United States
(12) Patent Application Publication
(10) Pub. No.: US 2021/0355970 A1
(43) Pub. Date: Nov. 18, 2021

(54) Device designed to be positioned close to a joint and general system comprising such a device

(71) Applicant: SAFRAN ELECTRONICS & DEFENSE, PARIS (FR)

(72) Inventors: Pascal LAROSE, SHERBROOKE (CA); Marc DENNINGER, SHERBROOKE (CA); Jean-Philippe LUCKING BIGUE, SHERBROOKE (CA); Jean-Sébastien PLANTE, SHERBROOKE (CA); Catherine VERONNEAU, SHERBROOKE (CA); Jordane GRENIER, SHERBROOKE (CA)

(21) Appl. No.: 17/289,654

(22) PCT Filed: Oct. 28, 2019
(86) PCT No.: PCT/EP2019/079398

§ 371 Date: Apr. 28, 2021

(30) Foreign Application Priority Data
Oct. 29, 2018 (FR) 18 60006

(51) Int. Cl. F15B 15/02; B25J 9/00; B25J 9/14; A61H 3/00; A61H 1/02

(52) U.S. Cl. CPC F15B 15/02; B25J 9/0006; B25J 9/144; A61H 2201/14; A61H 1/0266; A61H 2201/1246; A61H 3/00

(57) ABSTRACT

The invention relates to a device for positioning in the proximity of a joint between two portions, the device comprising a first interface (11) carried by a first of the two portions and a second interface (12) carried by a second of the two portions, the device including at least one connection between the first interface and the second interface, the connection comprising a double cylinder having two chambers that are connected together by a floating piston, the first of the two chambers being connected to the first interface and a second of the two chambers being connected to a drive rather of the double cylinder, said rod being connected to the second interface.

The invention also relates to a system including such a device.

The invention relates to a device for positioning in the proximity of a joint.

The invention also relates to a general system including such a device.

### TECHNOLOGICAL BACKGROUND OF THE INVENTION

An exoskeleton serves to augment the physical capabilities of a person in order to enable that person to perform certain tasks. Exoskeletons can thus be used in numerous applications, whether military, medical, industrial, . . . , and for purposes of physiotherapy, rehabilitation, assistance, . . . .

Nevertheless, it is found to be relatively complicated to make an exoskeleton that can follow the natural movements of the user, and in particular concerning complex joints of the ankle or knee type. The exoskeleton must thus be capable of activating the joint synchronously with the movements of the user in order to be able to assist the user in effective manner.

### OBJECT OF THE INVENTION

An object of the invention is to propose both a device that enables a joint to be actuated in effective manner, and also a general system including such a device.

### BRIEF DESCRIPTION OF THE INVENTION

In order to achieve this object, there is provided a device for positioning in the proximity of a joint between two portions, the device comprising a first interface carried by a first of the two portions and a second interface carried by a second of the two portions, the device including at least one connection between the first interface and the second interface.

According to the invention, the connection comprises a double cylinder having two chambers that are connected together by a floating piston, a first of the two chambers being connected to the first interface and a second of the two chambers being connected to an output rod of the double cylinder, said rod being connected to the second interface, the second chamber moving in service relative to the first chamber via the floating piston thus enabling the output rod to move the second portion of the joint relative to the first portion of the joint.

The invention thus enables the two portions of the joint to move relative to each other in simple and effective manner, in particular as a result of the configuration of the double cylinder.

Optionally, the output rod is mounted directly on the second interface.

Optionally, the output rod is hinged to the second interface

Optionally, the output rod is fastened in fixed manner to the second chamber.

Optionally, the device includes at least one guide for guiding sliding of the second chamber relative to the first chamber.

Optionally, the guide comprises at least one bushing-and-guide-shaft assembly.

Optionally, the device includes two guides for guiding sliding of the second chamber relative to the first chamber, the guides being arranged on opposite sides of the double cylinder.

Optionally, the guide for guiding sliding is external to the double cylinder.

Optionally, the device includes at least one secondary connection limiting any risk of unwanted sliding of the first interface along the associated portion.

Optionally, the secondary connection comprises a bar fastened in fixed manner at least at one of its ends to at least one of the interfaces.

Optionally, the secondary connection comprises a connecting rod hinged at least at one of its ends to at least one of the interfaces.

Optionally, the device is shaped to be positioned in service in the proximity of a user's ankle, the first interface being positioned on the user's shank and the second interface being positioned on the user's foot.

Optionally, the second interface is shaped to be in contact with the sole of a user's boot.

There is also provided a general system worn by a user, said general system comprising a device as described above together with a power supply unit for said device.

Optionally, the power supply unit includes at least one magneto-rheological fluid clutch.

Other characteristics and advantages of the invention appear on reading the following description of a particular, nonlimiting embodiment of the invention.

### BRIEF DESCRIPTION OF THE DRAWINGS

The invention can be better understood in the light of the following description given with reference to the accompanying figures, in which:

FIG. 1 is a perspective view of a general system worn by a user and including at least one device in a particular embodiment of the invention that is positioned in the proximity of one of said user's joints;

FIG. 2 is a perspective view on a larger scale of the device shown in FIG. 1, as worn by a user;

FIG. 3 is a longitudinal section view of the FIG. 2 device on its own, the double cylinder being in its deployed position;

FIG. 4 is a view similar to the view of FIG. 3, the double cylinder being in its retracted position; and

FIG. 5 is a perspective view on a larger scale of the power supply unit of the system shown in FIG. 1.

### DETAILED DESCRIPTION OF THE INVENTION

With reference to FIG. 1, in a particular embodiment of the invention, the general system comprises a first device 1 associated with a user's right angle and a second device 2 associated with the user's left ankle, together with a power supply unit 3 for delivering fluid to the first device 1 and to the second device 2 (which fluid may be a gas, or an optionally viscous liquid, . . . , with an optionally viscous liquid nevertheless being preferable to a gas). The system thus includes a first channel 4 connecting the power supply unit 3 to the first device 1, and a second channel 5 connecting the power supply unit 3 to the second device 2, both of the channels 4 and 5 also being worn by the user.

Furthermore, the power supply unit 3 is arranged on the user's lower back, e.g. by means of straps, a backpack, a belt, one or more elastic bands, . . .

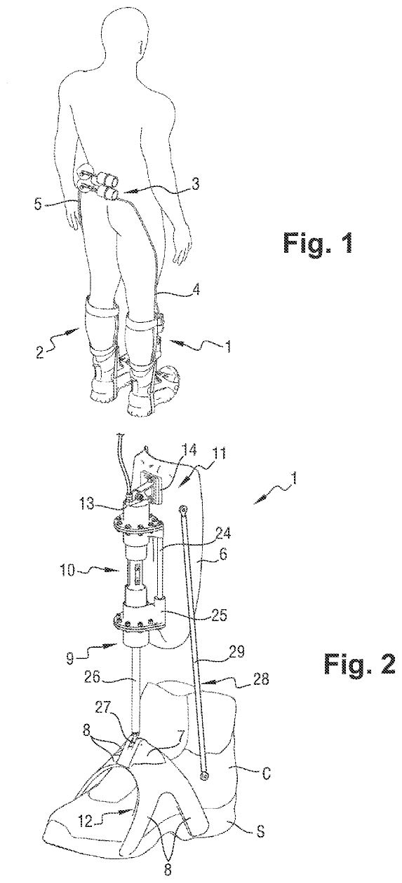

The first device 1 is described below with reference to FIGS. 2 to 4. In this example, since the second device 2 is identical to the first device 1, the description below is also applicable to the second device 2.

The device 1 includes a first interface 11 that is arranged on the user's shank (where the term “shank” is used herein to designate the portion of the human body that extends between the knee and the ankle). By way of example, the first interface 11 is secured to the shank by means of straps (not shown) or by any other attachment means. The first interface 11 is preferably arranged at the front of the user's shank overlying the tibia. As a result, the first interface 11 is above the user's foot.

The first interface 11 is advantageously shaped to match the shape of the front of the shank. For this purpose, the first interface 11 includes a shell 6 with its face that is to come into contact with the user being concave, of shape similar to the shape of the user's tibia.

The device 1 also includes a second interface 12 that is arranged on the user's foot. By way of example, the second interface 12 comprises a plate 7 extended by four attachment arms 8 for attaching to the user's boot C.

The attachment arms 8 are preferably of a size suitable for fastening the second interface 12 to the sole S of said boot C. The attachment arms 8 may extend in such a manner as to come into contact with the ground, or they may extend only as far as the sole S, which itself comes into contact with the ground.

The attachment arms 8 are preferably distributed symmetrically on the inside and on the outside of the boot C.

This ensures that the forces exerted by the second interface 12 of the boot C are well distributed during relative movement between the two interfaces 11 and 12.

The second interface 12 is thus arranged on the top and on the sides of the user's foot.

It should be observed that in this example, both of the interfaces 11 and 12 are rigid.

The device also includes a main connection 9 connecting together the first interface 11 and the second interface 12.

For this purpose, the main connection 9 comprises a double cylinder 10 having two chambers 21 and 22 connected together by a floating piston 23. In order to provide sealing between the two chambers 21 and 22, two rolling diaphragms are arranged between the floating piston 23 and respective ones of the chambers 21 and 22. The double cylinder 10 can thus equally well be referred to as a “double rolling diaphragm cylinder”.

The double cylinder 10 extends substantially longitudinally along an axis X. In this example, the device is arranged in such a manner that said axis X is substantially vertical.

A first one 21 of the two chambers is connected to the first interface 11. In this example, the first chamber 21 is mounted directly on the first interface 11.

By way of example, the first chamber 21 is hinge-mounted on the first interface 11.

Typically, the first chamber 21 is hinged to the first interface 11 by a ball joint or else by a pivot joint.

Typically, the top end 13 of the first chamber 21 is hinge-mounted to a proximal end 14 of the first interface 11.

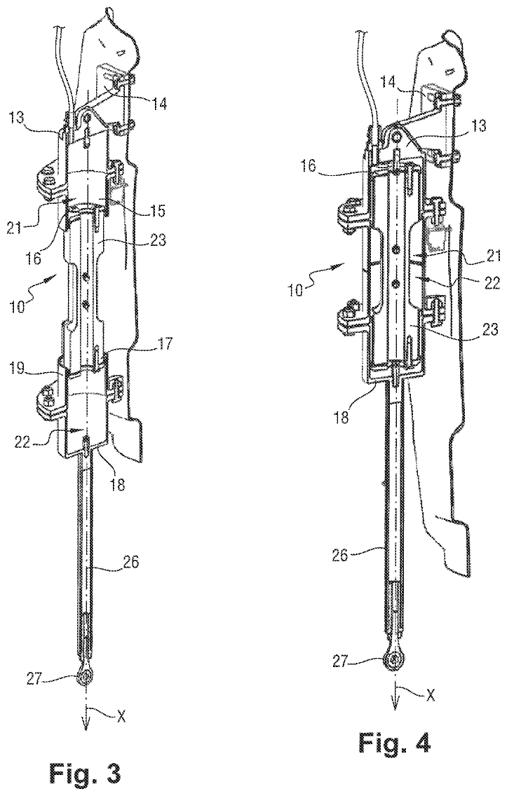

The first chamber 21 can thus pivot relative to the first interface 11. Furthermore, the piston 23 is movable in translation in the first chamber 21 along the axis X between a high position (shown in FIG. 4) in which the proximal end 16 of the piston 23 is substantially level with the top end 13 of the first chamber 21, and a low position (shown in FIG. 3) in which the proximal end 16 of the piston 23 is substantially level with the bottom end 15 of the first chamber 21.

Furthermore, the second chamber 22 is likewise movable in translation relative to the first chamber 21 along the axis X and movable in translation relative to the piston 23 along the axis X between a high position (shown in FIG. 4) in which the second chamber 22 is in contact with the first chamber 21, the distal end 17 of the piston 23 then being substantially level with the bottom end 18 of the second chamber 22, and a low position (shown in FIG. 3) in which the second chamber 22 is spaced apart from the first chamber 21, the distal end 17 of the piston 23 being substantially level with the top end of 19 of the second chamber 22.

It should thus be observed that the two chambers 21 and 22 form parts of the same double cylinder 10, but that each of them is formed in a respective distinct structure in order to allow the two chambers 21 and 22 to move relative to each other.

The floating piston 23 and the second chamber 22 are caused to move relative to the first chamber 21 by the power supply unit 3 supplying fluid to the double cylinder 10. For this purpose, the connection channel 4 leads into the double cylinder 10 at the top end 13 of the first chamber 21. Since all three of the first chamber 21, the second chamber 22, and the floating piston 23 are hollow, the fluid can thus flow between these three portions 21, 22, and 23 so as to allow the floating piston 23 to be deployed or to be retracted.

The double cylinder 10 thus presents a series configuration, thereby enabling it to have a stroke that is relatively long.

In order to guide the relative movement between the two chambers 21 and 22, the double cylinder 10 includes at least one bushing slidable along a guide shaft, the bushing and the guide shaft being associated with the two chambers 21 and 22 while being arranged outside the two chambers 21 and 22 and the floating piston 23.

In the present example, the double cylinder 10 has two guide shafts 24 (only one of which is visible in the figures) that are rigidly fastened to the first chamber 21 so as to extend outside the first chamber 21 on opposite sides of the first chamber 21, the guide shafts 24 thus being fastened in fixed manner relative to said first chamber 21. Both of the shafts 24 thus extend substantially parallel to the axis X, respectively on the right and on the left of the double cylinder 10. In corresponding manner, the second chamber 22 has two bushings 25 (only one of which is visible in the figures) that are slidable along respective ones of the guide shafts 24, the bushings 25 being rigidly fastened to the second chamber 22.

Furthermore, the double cylinder 10 has an output rod 26 that is connected to the second chamber 22. In this example, the output rod 26 has its first end rigidly fastened to the bottom end 18 of the second chamber 22.

In preferred manner, the second end 27 of the output rod 26 is mounted directly on the second interface 12. This enables the output rod 26 to actuate the second interface 12 directly without any intermediate actuator mechanism.

Likewise preferably, the second end 27 of the output rod 26 is hinged to the second interface 12.

This limits any risk of damaging the output rod 26 when it thrusts against the second interface 12. Also, this enables the device to follow the movements of the user's ankle more naturally.

Typically, the output rod 26 is hinged to the second interface 12, e.g. by a ball joint or else by a pivot joint.

In this example, the output rod 26 is mounted on the second interface 12 via the plate 7 of the second interface 12. Consequently, the output rod 26 acts on the second interface 12 in a manner that is offset from the axis about which the user's ankle flexes naturally. In particular, the output rod 26 acts on the attachment arms 8, which in turn act on the ground or on the sole S (depending on the size of the attachment arms 8).

It should also be observed that the drive shaft 26 forms a rigid structure providing good transmission of forces between the two interfaces 11 and 12.

In service, starting from a situation in which the double cylinder 10 is in its retracted position (as shown in FIG. 4), when the power supply unit 3 supplies fluid to the double cylinder 10, both the floating piston 23 and the second chamber 22 are caused to move progressively relative to the first chamber 22, and the second chamber 22 is also caused to move relative to the floating piston 23, potentially until the double cylinder 10 reaches its deployed position (as shown in FIG. 3).

Consequently, the output rod 26 exerts a thrust force progressively on the second interface 12, causing the second interface 12 to pivot relative to the first interface 11 and thus causing the ankle to pivot.

The device can thus assist the user when moving, whether for walking or running, and for applications that may be both civilian and military.

The above-described device is thus of relatively simple construction and it enables action to be taken directly on the second interface 12 via the drive shaft 26 of the double cylinder 10.

This makes it possible to have a device that is effective because it is very reactive. In particular, the above-described device avoids using belt-and-pulley type mechanisms that might be too springy.

The device is also found to be robust.

In particular manner, the device is arranged so that when the double cylinder 10 is in a middle position between its deployed position and its retracted position, the user's foot lies substantially in a horizontal plane.

In a preferred embodiment, in order to avoid the first interface 11 moving up along the tibia by reaction when the output rod 26 exerts thrust on the second interface 12, the device includes at least one secondary connection 28 that is arranged, in this example, between the first interface 11 and the user's boot C.

Preferably, the device has two secondary connections (only one of which is visible in the figures), each of which is arranged between the first interface 11 and the user's boot C. Each secondary connection 28 is typically arranged on a respective one of the right and left sides of the double cylinder 10 and outside the double cylinder 10.

Typically, each secondary connection 28 is in the form of a bar 29 fastened rigidly at a first end to the first interface 11 and fastened rigidly at a second end to the boot C.

The various bars 29 form rigid structures serving to take up the forces generated by the main connection 9 and thus to avoid unwanted movements of the first interface 11, and in particular to avoid the first interface 11 moving up along the user's tibia.

Optionally, the bars 29 are fastened at their second ends to the boot C. For example, each bar 29 is arranged to be fastened to a respective one of the side margins of the first interface 11 and to be fastened to a corresponding respective one of the outer sides of the boot C.

Each bar 29 is also preferably arranged in such a manner as to be fastened to the boot C substantially on the axis about which the ankle flexes.

This serves to minimize unwanted movements of the first interface 11 relative to the user, in particular such as the interface 11 sliding along the user's tibia.

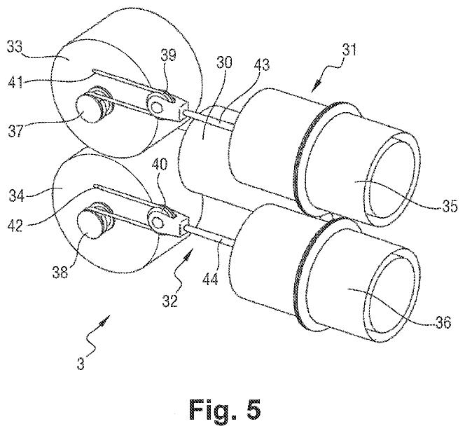

With reference to FIG. 5, there follows a description of the power supply unit 3 in a particular embodiment of the invention.

In this example, the power supply unit 3 comprises a power supply source 30, e.g. such as a motor, connected to a first power supply member 31 associated with the first device 1 and to a second power supply member 32 associated with the second device 2, the same power supply source 30 thus powering both of the power supply members 31 and 32.

This limits correspondingly both the weight of the power supply unit 3 and also its size. In the present example, using a single power supply source 30 is advantageous since, in order to assist the user in performing walking movements, the devices 1 and 2 need to be powered in alternation and not simultaneously.

Typically, each power supply member 31, 32 includes a magneto-rheological fluid clutch 33, 34 having an input shaft connected to the power supply source 30 and an output shaft. In service, the input shaft, under a rotary drive from the power supply source 30, in turn drives rotation of the output shaft when the magneto-rheological fluid present in the clutch 33, 34 is sufficiently viscous. If the magneto-rheological fluid is too liquid, the two shafts are not constrained together in rotation. By acting in this way of the viscosity of the magneto-rheological fluid, it is thus possible to control the torque that is transmitted between the two shafts.

This enables the power that is supplied to the devices 1 and 2 to be controlled finely.

Each power supply member 31, 32 also includes an output mechanism for transmitting fluid to the associated device. For this purpose, each output mechanism includes an output actuator 35, 36 connected to the output shaft of the associated clutch 33, 34, e.g. by a belt-and-pulley system and/or by any other transmission such as a cable, a Bowden cable, a chain, . . .

In particular manner, the transmission between the output shaft and the output actuator 35, 36 comprises a driving pulley 37, 38 secured to the output shaft and an associated driven pulley 39, 40 together with a belt 41, 42 attached at one end to the driving pulley 37, 38 and at its other end to a stationary structure, the belt 41, 42 also being wound around the driven pulley 39, 40. Furthermore, the output actuator 35, 36 has an actuation arm 43, 44 secured to the driven pulley 39, 40 so that rotation of the output shaft causes the belt 41, 42 to move, and consequently applies traction on the actuation arm 43, 44. By way of example, the ratio between the driving pulley 37, 38 and the driven pulley 39, 40 may be 2:1, but other ratios could be used.

Movement of the actuation arm 43, 44 then causes the fluid in the output actuator 35, 36 to move, and consequently moves the fluid in the channel going to the associated device 1, 2.

By way of example, the output actuator 35, 36 is a single rolling diaphragm cylinder, a cylinder without a rolling diaphragm, . . .

For further information about the power supply unit 3, reference may be made to the power supply unit described in International application PCT/CA2018/050570 filed on May 14, 2018, and incorporated herein by reference.

Naturally, the invention is not limited to the embodiment described, and variant embodiments may be provided without going beyond the ambit of the invention as defined by the claims.

Typically, although above the device is associated with a general system, the device could be independent. The device can thus have its own power supply unit that could be in the proximity of one or both interfaces, being carried by one or both interfaces, or else arranged apart from the two interfaces.

Furthermore, although above the device is associated with an ankle, the device could be associated with some other joint, e.g. such as a knee, a wrist, . . .

The device can be used in numerous applications, and by way of example it may be or form part of an exoskeleton, an orthosis, a prosthesis, a portable system, a system integrated in a robot, . . .

In the same manner, although above the device is worn by a human, the device could be worn by a robot.

One or both of the interfaces of a device could be integrated directly in a user's garments or footwear instead of being fastened thereto, as described above. For example, the second interface could be an integral portion of the user's boot.

The first chamber could be rigidly fastened to the first interface instead of being hinged thereto. Under such circumstances, if the double cylinder has one or more guide shafts, they could be fastened rigidly to the first chamber and/or to the first interface. Under such circumstances, the output rod and could then be hinged to the second chamber instead of being rigidly fastened thereto.

The output rod could be fastened to the second interface rigidly instead of being hinged thereto. Likewise, the output rod could then be hinged to the second chamber instead of being rigidly fastened thereto. The rod need not be connected directly to the second chamber and/or to the second interface. By way of example, a belt-and-pulley system (or any other connection mechanism) could be arranged between the output rod and the second interface and/or the second chamber, for example.

The device could have some other number of connections between the two interfaces. The device could thus have only one connection.

If the device includes secondary connections, they could be different from the above description.

For example, instead of bars that are fastened rigidly, it would be possible to use connecting rods hinged at one or both ends, e.g. via pivot joints or else via ball joints. This would impart better flexibility to the device. By way of example, each connecting rod could be hinged at a first end to the first interface and at a second end to the boot. For example, when using two connecting rods, each connecting rod could be arranged in such a manner as to be hinged to a respective side margin of the first interface and to be hinged to a corresponding outer side of the boot. Each connecting rod could also be arranged so as to be hinged to the boot substantially on the axis about which the ankle flexes. The various bars would then form rigid structures serving to take up the forces generated by the main connection and thus to avoid unwanted movements of the first interface, and in particular to avoid the first interface moving up along the user's tibia.

Under all circumstances, the or each secondary connection could be hinged or fastened in fixed manner at its second end to the sole of the boot, and not to the boot upper as shown. In the same manner, the or each secondary connection could be hinged or fastened in fixed manner at its second end to the second interface, and not directly to the boot, as shown. By way of example, the second interface could extend at least as far as the axis about which the ankle flexes so as to make it potentially possible for at least one secondary connection to be attached to the second interface on that axis.

A secondary connection should preferably be linked at least one of its ends to at least one of the interfaces.

A secondary connection could comprise a cylinder instead of a rigid structure such as a bar or a connecting rod, or indeed it could comprise straps or return members of spring or elastic type.

The secondary connections could be carried by the first interface and/or by the second interface and/or by a garment or by footwear of the user. A secondary connection could thus be carried directly at each of its ends by a respective one of the two interfaces.

The double cylinder could have guides other than the above-described bushing-and-guide-shaft assemblies. For example, the guides could be telescopic cylinders or belt-and-pulley assemblies. The double cylinder need not include a guide, or it may have some number of guides other than that described above.

The double cylinder could return to its retracted position naturally (when the foot returns fully onto the ground) and/or in a manner controlled by sucking the fluid out from the double cylinder and/or by means of a return member such as a spring, . . . The power supply unit could optionally produce torque for compensating any force produced by a return member.

The device could include elements other than those described, e.g. such as one or more sensors for measuring the force exerted by the user's foot on the ground or the force exerted by the second interface on the boot or the force exerted in the zone where the output rod thrusts against the second interface . . . and the sensor(s) could measure other parameters such as temperature, pressure, acceleration, position, . . .

The interfaces could be of shapes other than those described. For example, each interface may be in the shape of a sleeve. Means other than straps can be used for attaching the interfaces to the user, such as elastic bands, hook-and-loop type attachment strips (like the product sold under the Velcro trademark) . . . .

Likewise, the power supply unit associated with the device could be different from that described. For example, the power supply unit need not have a clutch between the motor and the main actuator, or it could have a different clutch, e.g. a clutch that is not a magneto-rheological fluid clutch. Likewise, the power supply unit need not include an output actuator, the motor and/or the clutch powering the device directly. The power supply unit could equally well include one or more speed reducers. The number of elements within the power supply unit may thus vary. For example, a different motor could be associated with each device, or indeed a single clutch could be associated with a plurality of devices.

All or a portion of the power supply unit could be carried by or form part of the device.

The system could include a number of devices different from that described, and for example it could include a single device.

1. A device for positioning in the proximity of a joint between two portions, the device comprising a first interface carried by a first of the two portions and a second interface carried by a second of the two portions, the device including at least one connection between the first interface and the second interface, the device being characterized in that the connection comprises a double cylinder having two chambers that are connected together by a floating piston, a first of the two chambers being connected to the first interface and a second of the two chambers being connected to an output rod of the double cylinder, said rod being connected to the second interface, the second chamber moving in service relative to the first chamber via the floating piston thus enabling the output rod to move the second portion of the joint relative to the first portion of the joint.

2. The device according to claim 1, wherein the output rod is mounted directly on the second interface.

3. The device according to claim 2, wherein the output rod is hinged to the second interface

4. The device according to claim 1, wherein the output rod is fastened in fixed manner to the second chamber.

5. The device according to claim 1, including at least one guide for guiding sliding of the second chamber relative to the first chamber.

6. The device according to claim 5, wherein the guide comprises at least one bushing-and-guide-shaft assembly.

7. The device according to claim 5, including two guides for guiding sliding of the second chamber relative to the first chamber, the guides being arranged on opposite sides of the double cylinder.

8. The device according to claim 5, wherein the guide for guiding sliding is external to the double cylinder.

9. The device according to claim 1, including at least one secondary connection limiting any risk of unwanted sliding of the first interface along the associated portion.

10. The device according to claim 9, wherein the secondary connection comprises a bar fastened in fixed manner at at least one of its ends to at least one of the interfaces.

11. The device according to claim 9, wherein the secondary connection comprises a connecting rod hinged at at least one of its ends to at least one of the interfaces.

12. The device according to claim 9, the device being shaped to be positioned in service in the proximity of a user's ankle, the first interface being positioned on the user's shank and the second interface being positioned on the user's foot.

13. The device according to claim 12, wherein the second interface is shaped to be in contact with the sole of a user's boot.

14. A system comprising a device according to claim 12, and a power supply unit for supplying fluid to said device.

15. The system according to claim 14, wherein the power supply unit includes at least one magneto-rheological fluid clutch.
